(19) United States
(12) Patent Application Publication
(10) Pub. No.: US 2026/0044130 A1
(43) Pub. Date: Feb. 12, 2026

(54) SURFACE MORPHING TECHNOLOGY USING AN INTERCONNECTED NETWORK OF CIRCULAR COMPLIANT ACTUATORS

(71) Applicant: Toyota Motor Engineering & Manufacturing North America, Inc., Plano, TX (US)

(72) Inventors: Lingfeng GAO, Albany, NY (US); Yuyang SONG, Ann Arbor, MI (US); Yuqing ZHOU, Ann Arbor, MI (US); Masato TANAKA, Plano, TX (US); Shikui CHEN, Albany, NY (US); Xianfeng GU, Albany, NY (US)

(73) Assignees: Toyota Motor Engineering & Manufacturing North America, Inc., Plano, TX (US); Toyota Jidosha Kabushiki Kaisha, Aichi-ken (JP); The Research Foundation for the State University of New York, Albany, NY (US)

(21) Appl. No.: 18/799,119

(22) Filed: Aug. 9, 2024

(51) Int. Cl. G05B 19/40

(52) U.S. Cl. CPC G05B 19/40; G05B 2219/34429

(57) ABSTRACT

Methods and systems may provide for an actuator including a circular sidewall having an inner surface, a first edge and a second edge, and a plurality of radial members extending from a hub of the actuator to the inner surface of the circular sidewall, wherein application of a force to an inner end of each radial member at the hub causes an outer end of the radial member to displace the second edge of the circular sidewall to a greater extent than the first edge of the circular sidewall.

### TECHNICAL FIELD

Embodiments generally relate to surface morphing technology. More particularly, embodiments relate to surface morphing technology using an interconnected network of circular compliant actuators.

### BACKGROUND

The ability to morph (e.g., physically transform) surfaces into various shapes can be advantageous in a variety of applications such as soft robotics, deployable structures in aerospace engineering, and adaptive automotive systems. The rational design and precise control of morphable structures, however, pose significant challenges due to the complex interplay between material properties, structural mechanics, and desired shape transformations.

### BRIEF SUMMARY

In one embodiment, an actuator assembly comprises one or more motors and a plurality of actuators coupled to the one or more motors, wherein each actuator includes a circular sidewall having an inner surface, a first edge and a second edge, and a plurality of radial members extending from a hub of the actuator to the inner surface of the sidewall, wherein application of a force by the one or more motors to an inner end of each radial member at the hub causes an outer end of the radial member to displace the second edge of the circular sidewall to a greater extent than the first edge of the circular sidewall, and wherein each actuator is coupled to two or more other actuators via sidewall connections.

In another embodiment, an actuator comprises a circular sidewall having an inner surface, a first edge and a second edge, and a plurality of radial members extending from a hub of the actuator to the inner surface of the circular sidewall, wherein application of a force to an inner end of each radial member at the hub causes an outer end of the radial member to displace the second edge of the circular sidewall to a greater extent than the first edge of the circular sidewall.

In yet another embodiment, a method of operating an actuator comprises determining a target curvature of the actuator, wherein the actuator includes a circular sidewall having an inner surface, a first edge and a second edge, and a plurality of radial members extending from a hub of the actuator to the inner surface of the circulator sidewall, and wherein the circular sidewall and the plurality of radial members are compliant, and applying a force to an inner end of each radial member at the hub based on the target curvature of the actuator, wherein application of the force to the inner end of each radial member at the hub causes an outer end of the radial member to displace the second edge of the circular sidewall to a greater extent than the first edge of the circular sidewall.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example of a transition of a two-dimensional (2D) profile in a model of an actuator assembly to a three-dimensional (3D) profile in the model of the actuator assembly according to an embodiment;

FIG. 2 is an illustration of an example of a set of discrete conformal mappings according to an embodiment;

FIG. 3 is an illustration of an example of circle packing for a metric according to an embodiment;

FIG. 4 is an illustration of an example of circle packing and curvature according to an embodiment;

FIG. 5 is a side view of an example of a radius change in a single circular actuator according to an embodiment;

FIG. 6 is a side view of an example of a radius change in two concentric circular layers connected by a series of radial spokes according to an embodiment;

FIG. 7 is an illustration of an example of a general boundary condition according to an embodiment;

FIG. 8 is an illustration of an example of a model of a radial member according to an embodiment;

FIG. 9A is a plot of an example of a level set optimization procedure according to an embodiment;

FIG. 9B is a side view of an example of a radial member in an initial position and a morphed position according to an embodiment;

FIG. 10 is a perspective view of an example of a plurality of radial members according to an embodiment;

FIG. 11 is a perspective view of an example of an actuator in an initial position and a morphed position according to an embodiment;

FIG. 12 is a perspective view of an example of an actuator assembly in an initial position and a morphed position according to an embodiment;

FIG. 13 is a block diagram of an example of surface morphing system according to an embodiment; and

FIG. 14 is a flowchart of an example of a method of operating an actuator according to an embodiment.

### DETAILED DESCRIPTION

Topology optimization has emerged as a powerful computational approach for designing structures with optimized material distribution to achieve desired performance objectives. By algorithmically determining the optimal layout of material within a design domain, topology optimization enables the creation of lightweight, high-performance, and multifunctional structures. In the context of morphable structures, topology optimization has been leveraged to design compliant mechanisms and shape-morphing systems. Existing approaches often struggle, however, to simultaneously maintain precise local geometries and overall shape integrity during the morphing process (e.g., limiting applicability to more complex target geometries).

To address these challenges, the technology described herein provides an enhanced framework that synergistically integrates computational conformal geometry and topology optimization for the design of morphable surface structures. Embodiments leverage circle packing, which is a technique to discretely represent surfaces using tangent circles, to model the target morphing behavior. Conformal mapping is then employed to deform the circle-packed surface between two-dimensional (2D) and three-dimensional (3D) configurations while preserving angle measurements. This conformality ensures that local geometries are maintained even as the global shape undergoes large deformations. By recasting the morphable surface design problem as the design of an interconnected network of circular compliant mechanisms, the technology described herein enables the application of topology optimization to generate physically realizable structures that can morph into the target geometries.

More particularly, the technology described herein introduces a conformal geometry-driven approach to model and control the morphing of surface structures based on circle packing and discrete Ricci flow (e.g., surface deformation according to an induced curvature, such that the curvature evolves like a heat diffusion process). This mathematical framework provides a principled way to describe and prescribe target morphing behaviors while preserving geometric fidelity.

For example, the introduction of circle packing offers several advantages for the kinematic modeling of morphable surface structures. Firstly, circle packing enables an accurate approximation of the local geometry of a surface, serving as a valuable tool for shape modeling. Secondly, conformal mapping preserves surface angles, thereby ensuring the overall shape integrity throughout the morphing process. Additionally, Ricci flow refines the surface shape and simulates the temporal evolution of the surface shape, facilitating the creation of highly realistic and dynamic models of morphable surface structures. This methodology is particularly beneficial for the physical realization of morphable structures using topology optimization, where maintaining both local and overall shape integrity during morphing ensures correct structural functionality.

Moreover, the technology described herein establishes a pipeline to integrate this conformal geometric modeling with topology optimization to automatically generate designs for morphable surface structures that can be fabricated as single-piece compliant mechanisms/members. The coupling of conformal geometry and topology optimization enables new solutions to design morphable structures with exceptional complexity and precision.

Through circle packing, overall surface morphing is transformed into localized changes in the radii of circle packs. This approach enables the morphable surface design problem to be reformulated as a circular actuator design problem. Consequently, the actuators can expand and contract in edge length and height, corresponding to changes in circle radius and curvature. Following the optimization of a single-piece topology-optimized compliant member, a circular actuator is assembled by revolving the compliant member (e.g., radial member) in a circular direction. Subsequently, the circular actuator is mapped to a circle packing pattern after numerical validation and experimentation, enabling adjustment of circle pack radii to morph the surface shape. Modifying the radii of the circle packing pattern through the proposed circular actuators facilitates the portability and deformability of the surface structure.

The technology described herein introduces the mathematical background on circle packing and conformal geometry that underpins an enhanced modeling approach, describes a pipeline to integrate conformal geometry with topology optimization (e.g., presenting the problem formulation), and details an enhanced topology optimization approach and sensitivity analysis. The following discussion also presents numerical examples and physical prototypes that demonstrate the effectiveness of the technology described herein and discusses the implications of embodiments on future research directions.

Turning now to FIG. 1, a model of an actuator assembly is shown in an initial (e.g., 2D) state 20, an intermediate state 22 and a morphed (e.g., 3D, deployed) state 24. In the initial state 20, the actuator assembly is a flat plane with uniform circle radii, in the intermediate state 22 the actuator assembly is following the Ricci flow with partially adjusted radii, and in the morphed state 24 the actuator assembly is a final deformed semi-spherical surface with target curvatures realized. In one example, the morphed state 24 represents a pop-up tent or other deployable structure.

### Circle Packing Theory

Circle packing is a useful tool from computational geometry that enables the representation of surfaces using a collection of circles with prescribed tangency relationships. By leveraging the properties of circle packings, such as the ability to capture local geometric information and shape invariance under conformal transformations, effective solutions can be developed to model and control the morphing of surface structures. Key mathematical concepts and theories underlying circle packing-based surface representation and manipulation are as follows.

### Koebe-Andreev-Thurston Theorem

The Koebe-Andreev-Thurston Theorem (KAT Theorem) is a fundamental theorem in the circle packing theory stating that for a finite maximal planar graph G, there exists a circle packing whose tangency graph is isomorphic to G and is unique, up to Möbius transformations and reflections in lines.

The KAT Theorem established a connection between the topology and the geometric realization of a finite graph. Furthermore, the KAT Theorem is closely related to the conformal mapping between planar domains. The Riemann mapping theorem states that, for any two topological disks in a plane, there is a conformal map from one disk to the other. It is not straightforward to construct, however, an explicit conformal mapping between two given domains.

Thurston proposed using circle packings to approximate conformal mappings. More particularly, Thurston suggested filling a domain Q with a hexagonal tessellation of circles, each of small radius r, and forming a planar graph G from the intersection graph of those circles. The KAT theorem guarantees a circle packing, with the outermost circle as the unit circle, whose tangency graph is isomorphic to G. The resulting discrete conformal mapping is the piecewise linear mapping that preserves the combinatorial structure of G.

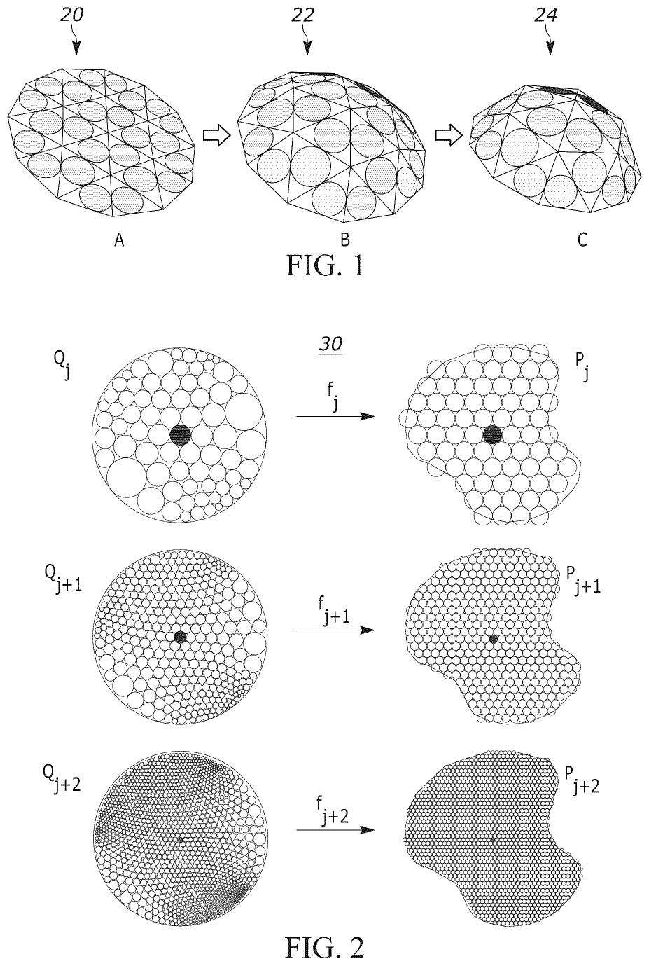

FIG. 2 demonstrates that a sequence of those discrete conformal mappings 30 (fₙ) can be obtained by sending the interior of a region Q to the unit disk D. Thurston conjectured that as the radius of the tessellation goes to zero, the discrete conformal mappings 30 fₙ will converge to the Riemann mapping. This conjecture was later confirmed.

### Discrete Ricci Flow and Circle Packing

There is no natural analogy, however, for circle packings on general curved surfaces. Ricci flow on surfaces has been introduced, as well as the relations between the Ricci flow and the circle packings (e.g., establishing the theoretical foundation for discrete Ricci flow).

Considering M as a two-dimensional, connected, orientable surface, and T as a simplicial triangulation of M, let V (T), E(T), F(T) be the set of vertices, edges, and triangles of T respectively. Furthermore, when M is equipped with a Riemannian metric, T is called a geodesic triangulation if every edge in T is a geodesic arc.

Given a triangulation T, if an edge length

$$l ∈ {ℝ}_{> 0}^{E ( T )}$$

satisfies the triangle inequalities, a Euclidean polyhedral surface (T, l) can be constructed by isometrically “gluing” the Euclidean triangles with the edge lengths defined by 1 along the pairs of edges. In this case, a Euclidean polyhedral surface exhibits a piecewise Euclidean metric, for a vertex in V (T) could be a singular cone point and the Gaussian curvature is constant zero at any point not in V (T).

Given (T, l)_{E}, let

$${θ}_{jk}^{i}$$

be the inner angle at the vertex i in the triangle Δijk. The discrete curvature Kᵢ at the vertex i V (T) is defined as

$${K}_{i} = 2 π - {\sum }_{jk ∈ E : Δ ijk ∈ F} {θ}_{jk}^{i} \qquad ( 1 )$$

A piecewise Euclidean metric is globally flat if and only Kᵢ=0 for every vertex i∈V(T).

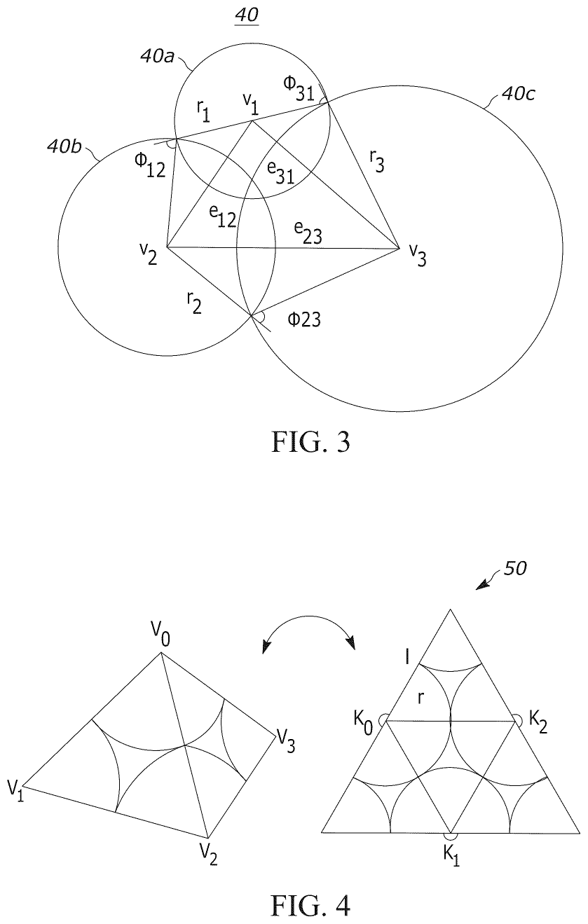

FIG. 3 illustrates a packing of a plurality of circles 40 (40a-40c). In practice, the studied objects are polyhedral surfaces that are related to circle packings, wherein infinitesimal circles are changed to circles with finite radii. Additionally, each circle 40 is centered at a vertex as in a cone, the radius is denoted as γᵢ at vertex vᵢ. Moreover, an edge has two vertices, wherein two circles 40 intersect one another with an intersection angle and the angle (e.g., weight) is denoted as Φ_{i j} for edge e_{i j}. In the illustrated example, triangle [v1, v2, v3] has vertices v1, v2, v3, and edges e12, e23, e31. The three circles 40 centered at v1, v2, and v3, with radii r1, r2 and r3 intersect one another, with intersection angles of Φ12, Φ23 and Φ31, which are the weights associated with the edges. The edge lengths of the triangle are determined by ri and Φi j, and by the cosine law.

FIG. 4 shows circle packing and curvature for a canonical tetrahedron 50 in which the edges lengths are all l=1.0 and the radius at each vertex is r=0.5. In the illustrated example, the curvature on each vertex equals to Ki=π and the weights on all edges are Φ=0.

Definition 1. A mesh with circle packing (M, Γ, Φ), where M is the topological triangulation (connectivity), Γ={γᵢ,vᵢ∈V} are the vertex radii, Φ={Φᵢⱼ,eᵢⱼ∈E} are the angles associated with each edge. A discrete conformal mapping τ:(M,Γ,Φ)→(M, \tilde{Γ}, Φ) only changes the vertex radii Γ, but preserves the intersection angles Φ.

In geometric modeling applications, meshes are typically embedded in [symbol] with the metrics induced from the embedding. The optimal weight Φ with initial circle radii Γ can be found, such that the circle packing metric (M, Φ, Γ) is as close as possible to the Euclidean metric in the least square sense. Namely, embodiments determine (M, Φ, Γ) by minimizing the following functional equation.

$${min}_{Γ , Φ} {\sum }_{{e}_{jk} ∈ E} {\vert {l}_{ij} - {\overline{l}}_{ij} \vert}^{2} \qquad ( 2 )$$

where Iᵢⱼ is the edge length of eᵢⱼ in [symbol] .

Then the discrete Ricci flow can be used to yield a virtual circle packing realizing the target curvature.

Definition 2 (Discrete Ricci flow). The discrete Ricci flow is defined as

$$\frac{d {γ}_{i}}{dt} = ( {\overline{K}}_{i} - {K}_{i} ) {γ}_{i} , \qquad ( 3 )$$

where \ddot{K}ᵢ is the desired discrete curvature.

As already noted, the discrete Ricci flow is a useful tool to manipulate circle packings and transform surface geometries. The discrete Ricci flow operates by adjusting the radii of the circles in a packing based on the difference between the current and target curvatures. The Ricci flow equation (Eq. 3) describes how the radius of each circle evolves over time, with the goal of converging to a packing that realizes the desired curvature distribution.

### Deformation for Surfaces Via Circle Packings

As already discussed, given an initial circle packing and the curvature for the target metric, the target metric can be achieved through the discrete Ricci flow.

The Alexandrov convex polyhedron theorem ensures that if the target curvature at each vertex is positive and the initial circle packing lies on the plane, it is possible to linearly interpolate the curvature to determine the curvature at intermediate states. Furthermore, the circle packings for those intermediate states could also be achieved through the discrete Ricci flow. This approach enables a deformation process to be outlined from the initial shape to the target shape via circle packing.

For non-convex target shapes, no theoretical guarantee ensures that the shape at intermediate steps could be embedded in R³. Satisfactory results can still be achieved, however, provided that the initial and target shapes are relatively small.

### Design of Morphable Surface Structures

### Concept of Morphable Surface Structures

A morphable surface structure may undergo deformation from a flat panel to a half sphere, causing simultaneous changes in the radii of individual circles. Circle-packing algorithms yield accurate and precise data for each circle during this transformation. Leveraging this radius data, the technology described herein devises a radial member capable of morphing in accordance with the data and adjusting the radii accordingly. Given that the radius changes induced by singular circular units alone are insufficient to achieve the overall transformation from a flat panel to a half sphere, there is a growing importance for the significance of curvature changes brought about by individual circles in this process.

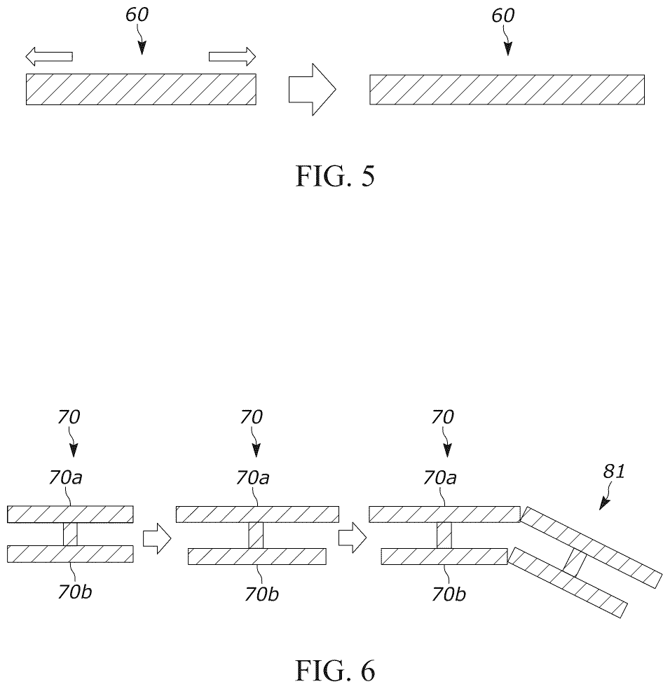

Turning now to FIG. 5, achieving radius changes in a single circular actuator 60 is conceptually straightforward. The fundamental concept involves an expansion and pulley mechanism capable of altering the size of the actuator 60 while preserving the circular form of the actuator 60. This principle may find application in machine gearing adjustments, where dynamic modulation of the pulley radius facilitates changes in gear ratio. The expansion and pulley actuator smoothly adjusts the radius by harnessing motive power, which can be supplied by a motor or similar device. Achieving curvature changes in the single circular actuator 60 presents a significant challenge, as the change involves bending the member to approximate the target curvature.

FIG. 6 demonstrates an enhanced approach to not only achieving curvature alterations but also radius changes by incorporating an additional upper layer 70a into a member 70 (70a-70b). The upper layer 70a of the member 70 expands over a greater distance compared to a lower layer 70b, resulting in a disparity in length between the two layers 70a, 70b (e.g., radial spokes). This length difference generates curvature when the member 70 comes into contact with another surface 81. Building on this concept, embodiments may include a double expansion and pulley solution to not only achieve curvature alterations but also achieve radius changes.

In one example, the double expansion and pulley solution includes two concentric circular sidewalls connected by a series of radial spokes. Each sidewall is composed of a flexible material that can expand or contract in response to an applied force. The upper layer 70a has a slightly larger radius than the lower layer 70b, allowing for differential expansion. The radial spokes ensure that the layers maintain a circular shape during expansion and contraction.

To actuate the member 70, a set of pulleys and cables can be employed. For example, the cables might be attached to the outer edge of each layer 70a, 70b and routed through the pulleys, which are mounted on a fixed frame surrounding the member 70. By selectively pulling on the cables, the upper layer 70a can be made to expand more than the lower layer 70b, causing the member 70 to bend and assume a curved shape. The curvature of the member 70 can be controlled by adjusting the relative expansion of the two layers 70a, 70b. At the same time, the overall radius of the member 70 can be changed by expanding or contracting both layers 70a, 70b simultaneously.

The illustrated double expansion and pulley solution offers several advantages over alternative designs. First, by using flexible materials and a simple actuation scheme, the member 70 can achieve smooth and controllable curvature changes without the need for complex hinges or joints. Second, the use of concentric layers 70a, 70b allows for independent control of radius and curvature, enabling a wide range of target shapes to be realized. Finally, the member 70 can be easily scaled up or down to suit different application constraints, from small-scale soft robotic components to large-scale adaptive structures.

In the context of morphable surface design, the double expansion and pulley solution serves as a key building block for realizing the target curvature distributions prescribed by circle packing-based surface representations. By integrating multiple instances of the member 70 into a larger structure and coordinating actuation, complex surface geometries can be achieved. The precise control afforded by the member 70 enables the realization of smooth, continuous shape transformations, as appropriate in many morphable surface applications.

### Rigid Body Solutions Versus Compliant Solutions

A rigid body solution boasts versatile engineering applications and may find widespread use in manufacturing, robotics, automotive, aerospace, mechanical engineering, and other fields. The ability of a rigid body solution to efficiently transmit force and motion between components without undergoing deformation may make such a solution highly advantageous (e.g., interconnecting parts via joints facilitate relative motion between the parts). While an expansion and pulley solution effectively meets design requirements for expanding radii and morphing curvature with stability and precision, larger systems comprising numerous parts may pose increased risks such as buckling and failure.

By contrast, compliant solutions offer other advantages such as flexibility, adaptability, lightweight construction, simplified design, and ease of manufacturing. Fabricating compliant mechanisms via 3D printing enables single-piece construction, enhancing convenience and reducing assembly complexity. Indeed, employing lightweight single-circular members may enhance overall system stability.

### Shape and Topology Optimization of Compliant Members

### Level Set Optimization Overview

Topology optimization, a shape optimization method, employs procedural models to optimize material distribution within a predefined design domain, considering specified objective functions, constraints, and boundary conditions. In recent years, topology optimization may have garnered increasing popularity and attention within engineering design circles. The scope of topology optimization has expanded significantly to address a wide array of challenges involving multi-physics coupling, spanning electromagnetics, thermodynamics, acoustics, solid mechanics, fluid mechanics, and so forth.

A level set optimization may employ a high-dimensional function to implicitly represent a 2D contour. Additionally, a level set optimization procedure can ensure a clear boundary between phases without a “grey” region, significantly enhancing precision and optimization accuracy. In this framework, the structural boundary is implicitly represented as a 2D contour of a level set function with one higher dimension implicitly embedded within the level set function Φ(x, t). Depending on the sign of the level set function, the design domain can be partitioned into three distinct regions, representing the material, the interface, and the void, respectively, as follows:

$$\{ \begin{matrix}Φ ( x , t ) > 0 , & x ∈ Ω , & Material \\ Φ ( x , t ) = 0 , & x ∈ \partial Ω , & Boundary \\ Φ ( x , t ) < 0 , & x ∈ D / Ω , & Void\end{matrix} \qquad ( 4 )$$

where D denotes the design domain. The evolution of the boundary dynamics is governed by the Hamilton-Jacobi equation:

$$\frac{\partial Φ ( x , t )}{\partial t} - {V}_{n} \cdot \vert ∇ Φ ( x , t ) \vert = 0 , \qquad ( 5 )$$

The normal velocity field Vₙ can be determined through shape sensitivity analysis. Solving the Hamilton-Jacobi equation outlined above enables the updating of the normal velocity field, which subsequently governs the evolution of the structural boundary.

### Problem Formulation

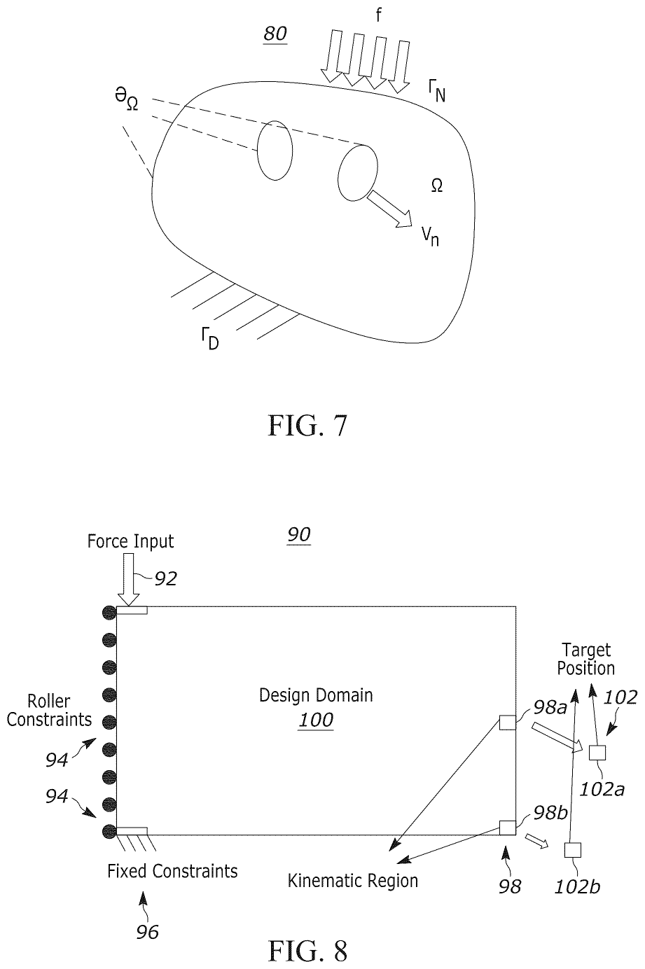

FIG. 7 shows a schematic 80 of a general boundary condition in which the objective of the topology optimization problem for the single-piece compliant actuator is twofold: (1) kinematic performance: minimizing the discrepancy between the target and actual deformation of the actuator, and (2) load-carrying capability: maximizing the structural stiffness while maintaining a prescribed volume fraction. The problem can be mathematically formulated as follows:

$$Minimize : J = {ω}_{1} ( {\int }_{Ω} {ε}_{ij} ( u ) {E}_{ijkl} {ε}_{kl} ( u ) d Ω ) \qquad ( 6 )$$

$$+ {{ω}_{2} ( {\int }_{Ω} k {\vert u - {u}_{0} \vert}^{α} d Ω )}^{\frac{1}{α}} ,$$

$$α = 2$$

$$Subject to : a ( u , v ) = l ( v ) , ∀ v ∈ U$$

$$V ( Ω ) = V * .$$

where u is the state variable (e.g., displacement) in the admissible displacement space; Ω is the shape of the material region in the design domain; D represents the design domain; ε_{i j} is the strain tensor; E_{i jkl} is the elasticity tensor; u₀ is the target displacement; k is a weighting factor; ω₁ and ω₂ are weighting coefficients for the stiffness and displacement objectives, respectively; a(u, v) and l(v) are the energy bilinear form and the load linear form, respectively; U is the space of admissible displacements; and V* is the prescribed volume fraction.

The first term in the objective functional J represents the structural stiffness, while the second term measures the discrepancy between the actual and target displacements using an L^{a}−norm. The parameter a is set to 2, resulting in a quadratic penalty for deviations from the target displacement.

The constraint a(u, v)=l(v) ensures that the displacement field satisfies the governing equations of linear elasticity. The volume constraint V(Ω)=∫_{Ω}H(φ)dΩ=V* limits the amount of material that can be used in the design, k is a region indicator, which equals one inside a specific region and zero outside the specific region.

### Shape Sensitivity Analysis

The topology optimization problem for the single-piece soft actuator can be formulated as a PDE (partial differential equation)-constrained optimization problem. To solve this problem, the Lagrange multipliers method can be utilized to transform the PDE-constrained problem into an unconstrained optimization problem. This transformation is achieved by defining the Lagrangian functional L as follows, which integrates the objective function and governing equation with a Lagrange multiplier λ.

$$L = J + λ ( a ( u , v ) - l ( v ) ) , \qquad ( 7 )$$

where J is the objective functional, a(u, v) represents the weak form of the governing equations, and l(v)) is the load functional.

### Adjoint Equation Derivation

To derive the adjoint equation, the variation of the Lagrangian functional L can be taken with respect to the state variable u and the Lagrange multiplier λ:

Setting δ L=0 leads to the adjoint equation:

$$a ( {u}^{′} , v ) = - \frac{δ J}{δ u} \qquad ( 8 )$$

where v is the adjoint variable and u′ is the test function.

As for this problem, the total derivative of the objective function and governing equation is as follows:

$$\frac{DL}{Dt} = \frac{DJ}{Dt} + \frac{Da ( u , v )}{Dt} - \frac{Dl ( v )}{Dt} \qquad ( 9 )$$

The material time derivative of the objective function is formulated as:

$$\begin{matrix}\frac{DL}{Dt} = \frac{\partial J}{\partial t} + \frac{\partial J}{\partial Ω} \\ \frac{\partial J}{\partial t} = 2 {ω}_{1} ( {\int }_{Ω} {ε}_{ij} ( {u}^{′} ) {E}_{ijkl} {ε}_{kl} ( u ) d Ω ) + {{ω}_{2} ( {\int }_{Ω} k \vert u - {u}_{0} {\vert}^{2} d Ω )}^{- \frac{1}{2}} \cdot {\int }_{Ω} k ( u - {u}_{0} ) \cdot {u}^{′} d Ω \\ \frac{\partial J}{\partial Ω} = {ω}_{1} ( {\int }_{Ω} {ε}_{ij} ( u ) {E}_{ijkl} {ε}_{kl} ( u ) {V}_{n} ds ) + \frac{{ω}_{2}}{2} {( {\int }_{Ω} k \vert u - {u}_{0} {\vert}^{2} d Ω )}^{- \frac{1}{2}} \cdot {\int }_{\partial Ω} {k ( u - {u}_{0} )}^{2} \cdot {V}_{n} ds\end{matrix} \qquad ( 10 )$$

The material time derivative of the energy form and the load form can be expressed as:

$$\begin{matrix}\frac{Da ( u , v )}{Dt} = \frac{\partial a ( u , v )}{\partial t} + \frac{\partial a ( u , v )}{\partial Ω} \\ \frac{\partial a ( u , v )}{\partial t} = {\int }_{Ω} {ε}_{ij} ( {u}^{′} ) {E}_{ijkl} {ε}_{kl} ( v ) d Ω + {\int }_{Ω} {ε}_{ij} ( u ) {E}_{ijkl} {ε}_{kl} ( {v}^{′} ) d Ω \\ \frac{\partial a ( u , v )}{\partial Ω} = {\int }_{Ω} {ε}_{ij} ( u ) {E}_{ijkl} {ε}_{kl} ( v ) {V}_{n} ds\end{matrix} \qquad ( 11 )$$

Where v is the adjoint displacement,

$$\frac{Dl ( v )}{Dt} = \frac{\partial l ( v )}{\partial t} + \frac{\partial l ( v )}{\partial Ω} = {\int }_{Ω} g \cdot {v}^{′} d Ω + {\int }_{{Γ}_{N}} f \cdot {v}^{′} d {Γ}_{N} + {\int }_{\partial Ω} g \cdot {vV}_{n} ds + {\int }_{\partial Ω} [ \frac{\partial ( f \cdot v )}{\partial n} + k ( f \cdot v ) {V}_{n} ] ds \qquad ( 12 )$$

Here, the total derivative can be rewritten as:

$$\frac{DL}{Dt} = 2 {ω}_{1} ( {\int }_{Ω} {ε}_{ij} ( {u}^{′} ) {E}_{ijkl} {ε}_{kl} ( u ) d Ω ) + {{ω}_{2} ( {\int }_{Ω} k \vert u - {u}_{0} {\vert}^{2} d Ω )}^{- \frac{1}{2}} \cdot {\int }_{Ω} k ( u - {u}_{0} ) \cdot {u}^{′} d Ω + {ω}_{1} ( {\int }_{Ω} {ε}_{ij} ( u ) {E}_{ijkl} {ε}_{kl} ( u ) {V}_{n} ds ) + \frac{{ω}_{2}}{2} {( {\int }_{Ω} k \vert u - {u}_{0} {\vert}^{2} d Ω )}^{- \frac{1}{2}} \cdot {\int }_{\partial Ω} {k ( u - {u}_{0} )}^{2} \cdot {V}_{n} ds + {\int }_{Ω} {ε}_{ij} ( {u}^{′} ) {E}_{ijkl} {ε}_{kl} ( v ) d Ω + {\int }_{Ω} {ε}_{ij} ( u ) {E}_{ijkl} {ε}_{kl} ( {v}^{′} ) d Ω + {\int }_{Ω} {ε}_{ij} ( u ) {E}_{ijkl} {ε}_{kl} ( v ) {V}_{n} ds - {\int }_{Ω} g \cdot {v}^{′} d Ω + {\int }_{{Γ}_{N}} f \cdot {v}^{′} d {Γ}_{N} - {\int }_{\partial Ω} g \cdot {vV}_{n} ds - {\int }_{\partial Ω} [ \frac{\partial ( f \cdot v )}{\partial n} + k ( f \cdot v ) {V}_{n} ] ds \qquad ( 13 )$$

Solving the adjoint equation yields,

$$2 {ω}_{1} ( {\int }_{Ω} {ε}_{ij} ( {u}^{′} ) {E}_{ijkl} {ε}_{kl} ( u ) d Ω ) + {{ω}_{2} ( {\int }_{Ω} k \vert u - {u}_{0} {\vert}^{2} d Ω )}^{- \frac{1}{2}} \cdot {\int }_{Ω} k ( u - {u}_{0} ) \cdot {u}^{′} d Ω + {\int }_{Ω} {ε}_{ij} ( {u}^{′} ) {E}_{ijkl} {ε}_{kl} ( v ) d Ω \qquad ( 14 )$$

Let D₀=(∫_{Ω}k|u−u₀|²dΩ)^{-3/2}, then the above equation can be written as,

$${\int }_{Ω} {ε}_{ij} ( {u}^{′} ) {E}_{ijkl} {ε}_{kl} ( v ) d Ω = - {ω}_{2} {D}_{0} \cdot {\int }_{Ω} k ( u - {u}_{0} ) \cdot {u}^{′} d Ω - 2 {ω}_{1} ( {\int }_{Ω} {ε}_{ij} ( {u}^{′} ) {E}_{ijkl} {ε}_{kl} ( u ) d Ω ) \qquad ( 15 )$$

### Since

$${\int }_{Ω} {ε}_{ij} ( {u}^{′} ) {E}_{ijkl} {ε}_{kl} ( u ) d Ω = {\int }_{Ω} g \cdot {u}^{′} d Ω + {\int }_{{Γ}_{8}} f \cdot {u}^{′} d {Γ}_{N} \qquad ( 16 )$$

$${\int }_{Ω} {ε}_{ij} ( {u}^{′} ) {E}_{ijkl} {ε}_{kl} ( v ) d Ω = - {ω}_{2} {D}_{0} \cdot {\int }_{Ω} k ( u - {u}_{0} ) \cdot {u}^{′} d Ω - 2 {ω}_{1} {\int }_{Ω} g \cdot {u}^{′} d Ω - 2 {ω}_{1} {\int }_{{Γ}_{N}} f \cdot {u}^{′} d {Γ}_{N} \qquad ( 17 )$$

$${\int }_{Ω} {ε}_{ij} ( {u}^{′} ) {E}_{ijkl} {ε}_{kl} ( v ) d Ω = {\int }_{Ω} ( - {ω}_{2} {D}_{0} \cdot k ( u - {u}_{0} ) - 2 {ω}_{1} g ) \cdot {u}^{′} d Ω + {\int }_{{Γ}_{N}} ( - 2 {ω}_{1} \cdot f ) \cdot {u}^{′} d {Γ}_{N}$$

The strong form of the adjoint solution is as follows:

$$\begin{matrix}- ∇ \cdot σ ( v ) = - {ω}_{2} {D}_{0} \cdot k ( u - {u}_{0} ) - 2 {ω}_{1} g , on Ω , \\ v = 0 , on {Γ}_{D} , \\ σ ( v ) \cdot n = - 2 {ω}_{1} \cdot f , on {Γ}_{N} ,\end{matrix} \qquad ( 18 )$$

### Construction of Design Velocity

Once the adjoint equation is solved, the design velocity Vₙ can be calculated using the following expressions. In the technology described herein, the body force g may be disregarded in the problem:

$${ω}_{1} ( {\int }_{\partial Ω} {ε}_{ij} ( u ) {E}_{ijkl} {ε}_{kl} ( u ) {V}_{n} ds ) + \frac{{ω}_{2}}{2} {( {\int }_{Ω} k \vert u - {u}_{0} {\vert}^{2} d Ω )}^{- \frac{1}{2}} \cdot {\int }_{\partial Ω} {k ( u - {u}_{0} )}^{2} \cdot {V}_{n} ds + {\int }_{\partial Ω} {ε}_{ij} ( u ) {E}_{ijkl} {ε}_{kl} ( v ) {V}_{n} ds \qquad ( 19 )$$

With the steepest descent method, the normal design velocity can be constructed as

$$\begin{matrix}{V}_{n 1} = - {ω}_{1} {ε}_{ij} ( u ) {E}_{ijkl} {ε}_{kl} ( u ) \\ {V}_{n 2} = - \frac{{ω}_{2}}{2} {D}_{0} {k ( u - {u}_{0} )}^{2} \\ {V}_{n 3} = - {ε}_{ij} ( u ) {E}_{ijkl} {ε}_{kl} ( v )\end{matrix} \qquad ( 20 )$$

The total design velocity Vₙ is then obtained by summing these three components:

$${V}_{n} = - {ω}_{1} {ε}_{ij} ( u ) {E}_{ijkl} {ε}_{kl} ( u ) - \frac{{ω}_{2}}{2} {D}_{0} {k ( u - {u}_{0} )}^{2} - {ε}_{ij} ( u ) {E}_{ijkl} {ε}_{kl} ( v ) \qquad ( 21 )$$

In one example, design velocity is used to evolve the structural boundary and optimize the topology of the compliant actuator.

### Topology Optimization Example

FIG. 8 shows a model 90 of a single-piece actuator (e.g., radial member) according to an example. The boundary conditions of the single-piece actuator are a force input 92 at the top left, roller constraints 94 at the left edge, and fixed constraints 96 at the bottom left. Two squares 98 (98a-98b) within a design domain 100 indicate a kinematic region and two squares 102 (102a-102b) indicate the target position of the kinematic region. The target position is determined by circle packing procedures. Based on the data generated, the corresponding radii and the curvature target of every single circular actuator can be found from the overall radii. The window factor k can be zero except in the kinematic region where it is equal to one. In one example, the force applied is 3 Newton (N), the material used is a dummy material with Young's modulus E=1000 Pascal (Pa), the Poisson's ratio is given by 0.3, and the density is 1. In such a case, the weighting factor of this topology optimization problem is w₁=0.0042, w₂=0.9958.

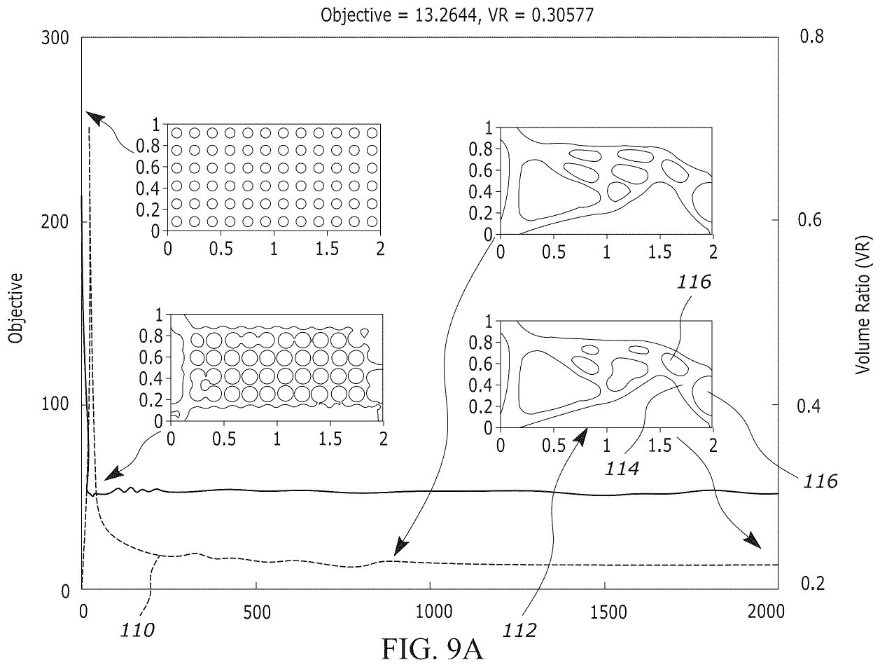

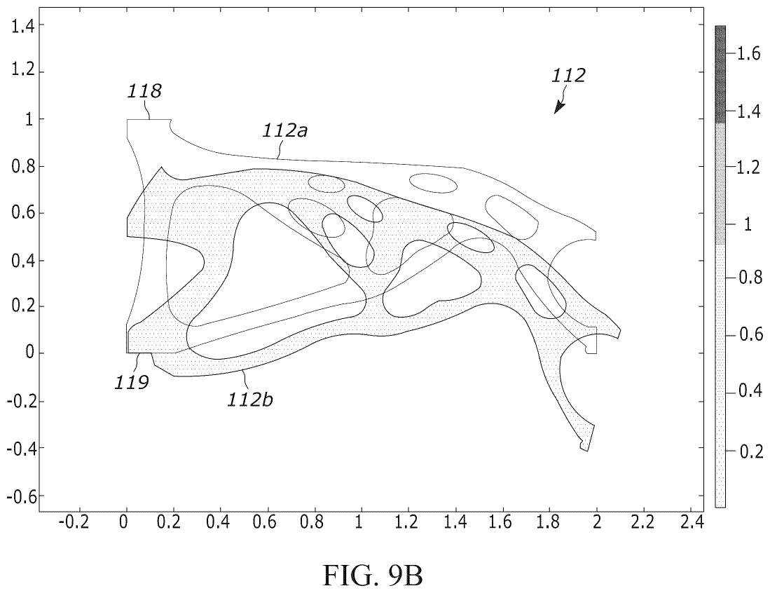

Turning now to FIGS. 9A and 9B, the entire design domain may discretized into a grid (e.g., 100×50 cells), wherein constituent materials are constrained to occupy a specified percentage (e.g., 30%) of the total volume. In the illustrated example, a convergence curve 110 demonstrates the optimization process and the history of design evolution (e.g., for a total of 2000 iterations).

Once the iterations have completed, the optimization outcome is a radial member 112 (112a-112b) having material regions 114 and surfaces defining void regions 116. In this example, finite element analysis is carried out to verify level set optimization results, with boundary conditions applied to the optimized outcome. As best seen in FIG. 9B, a downward (e.g., compressive) force (e.g., 3 Newton) is applied between a compressible portion 118 and a fixed portion 119 of the radial member 112, and the kinematic region converges from an initial state 112a toward the target position at a morphed state 112b. In one example, the final volume ratio is 30% and the radial member 112 (e.g., single-piece soft actuator) successfully meets the design criteria (e.g., according to finite element analysis).

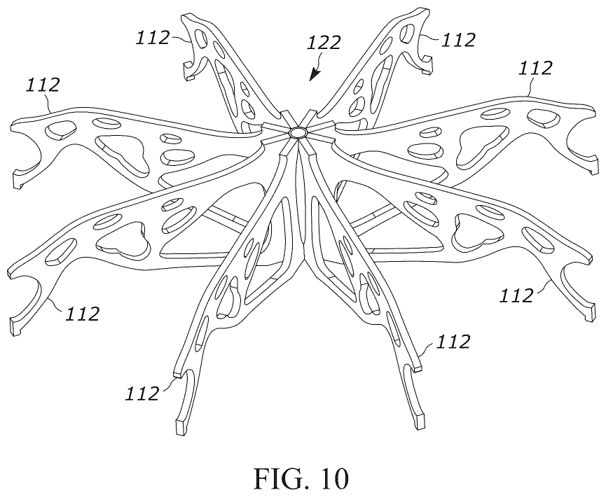

FIG. 10 demonstrates that utilizing symmetry, an actuator assembly 120 can be constructed from the circular pattern of radial members 112. In the illustrated example, eight radial members are assembled to form one circular actuator assembly 120. A force is applied to a hub 122 at the top of the circular actuator assembly 120, resulting in the bending and expansion of the entire structure according to the designed curvature and radius. In an embodiment, the force is generated by a motor or similar device.

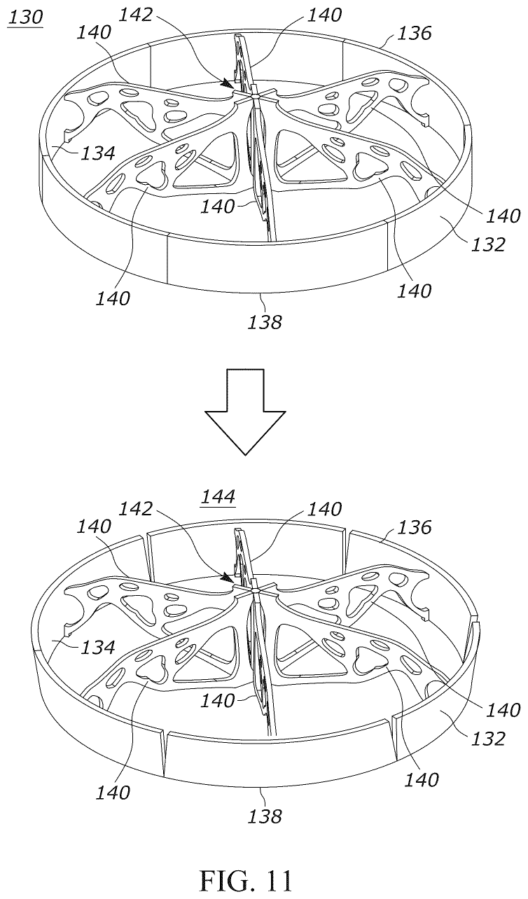

FIG. 11 shows an actuator in a first state 130 prior to actuation. The illustrated actuator includes a circular sidewall 132 having an inner surface 134, a first edge 136 and a second edge 138. The actuator also includes a plurality (e.g., six) radial members 140 extending from a hub 142 of the actuator to the inner surface 134 of the circular sidewall 132. In an embodiment, the circular sidewall 132 and the plurality of radial members 140 are compliant. Accordingly, application of a force (e.g., compressive force) to an inner end of each radial member at the hub 142 causes an outer end of the radial member 140 to displace the second edge 138 of the circular sidewall 132 to a greater extent than the first edge 136 of the circular sidewall. The displacement of the second edge 138 to the greater extent than the first edge 136 generates a curvature in a profile of the actuator when the actuator is in a second state 144. In one example, the curvature is a circle packing curvature. Additionally, the plurality of radial members may be associated with a level set optimization procedure. The actuator is therefore considered performance-enhanced at least to the extent that the differential displacement provided by the radial members enables coordinated control of the morphable surface.

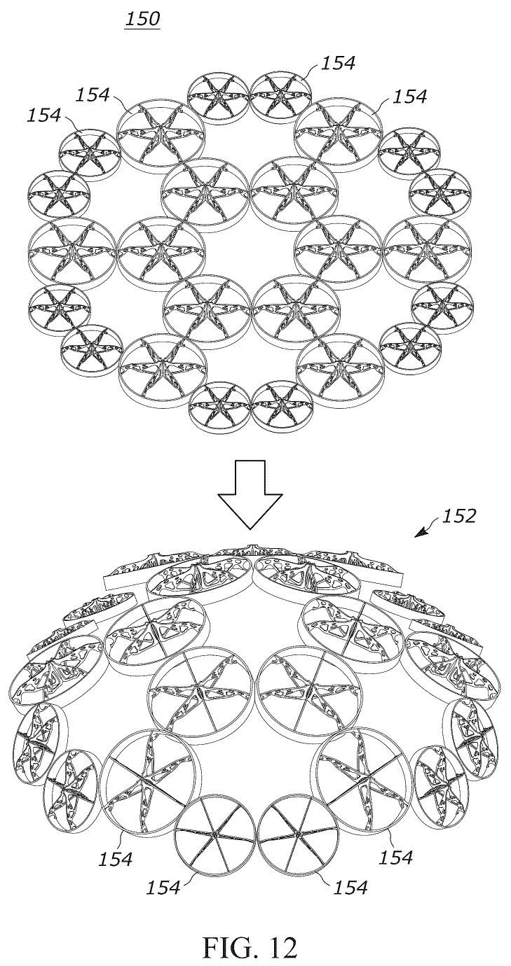

FIG. 12 shows an actuator assembly in a first (e.g., 2D) state 130 and a second (e.g., 3D) state 152. The second state 152 is useful in various applications such as soft robotics, deployable structures (e.g., pop-up tents), adaptive automotive systems, and so forth. The actuator assembly includes one or more motors (not shown) and a plurality of actuators 154 coupled to the motor. As already noted, each actuator 154 includes a circular sidewall having an inner surface, a first edge and a second edge. In the illustrated example, each actuator 154 also includes a plurality of radial members extending from a hub of the actuator 154 to the inner surface of the circular sidewall, wherein application of a force by the motor to an inner end of each radial member at the hub causes an outer end of the radial member to displace the second edge of the circular sidewall to a greater extent than the first edge of the circular sidewall. In an embodiment, each actuator 154 is coupled to two or more other actuators 154 via sidewall connections (e.g., spot or line weld, adhesive, rivets, etc., in a prescribed tangency relationship) and different forces are applied to the actuators 154 to achieve different shapes in the second state 152. The illustrated actuator assembly includes twenty-four actuators 154, although a different number of actuators may be used depending on the circumstances.

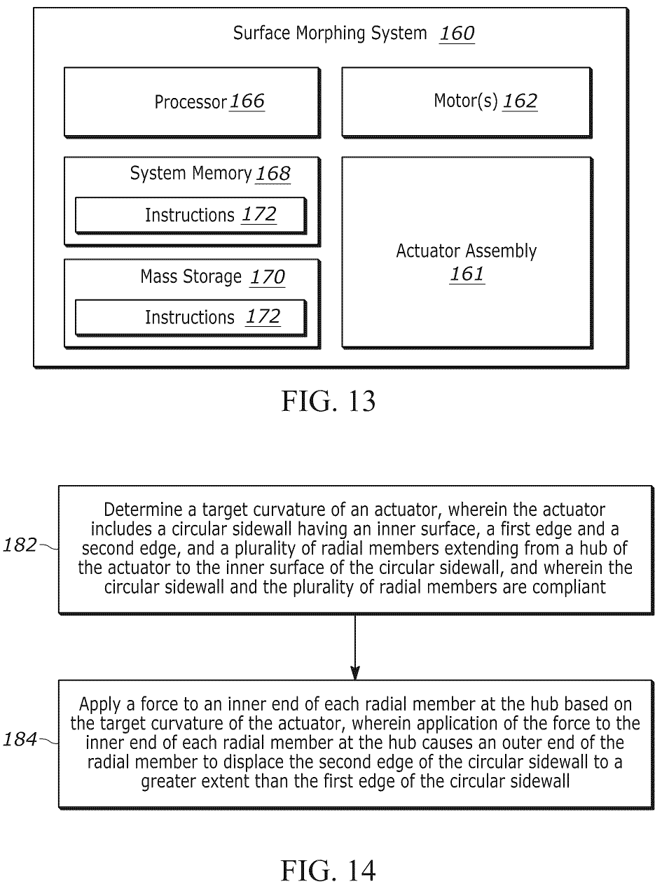

FIG. 13 shows a surface morphing system 160 having one or more motors 162, an actuator assembly 164 coupled to the motor(s) 162, a processor 166 coupled to the motor(s) 162, a system memory 168 (e.g., dynamic random access memory/DRAM or other volatile memory) and mass storage 170 (e.g., solid state drive/SSD, optical disc, hard disk drive/HDD or other non-volatile memory). In an embodiment, the processor 166 executes instructions 172 retrieved from the system memory 168 and/or the mass storage 170 to control the actuator assembly 164 via the motor(s) 162. Thus, execution of the instructions 172 can cause the processor 166 and/or the surface morphing system 160 to determine target curvatures of actuators in the actuator assembly 164, wherein each actuator includes a circular sidewall having an inner surface, a first edge and a second edge. Each actuator also includes a plurality of radial members extending from a hub of the actuator to the inner surface of the circular sidewall, wherein the circular sidewall and the plurality of radial members are compliant. Execution of the instructions 172 can also cause the processor 166 and/or the surface morphing system 160 to apply a force to an inner end of each radial member at the hub based on the target curvature of the actuator, wherein application of the force to the inner end of each radial member at the hub causes an outer end of the radial member to displace the second edge of the circular sidewall to a greater extent than the first edge of the circular sidewall.

FIG. 14 shows a method 180 of operating an actuator such as, for example, the actuators 154 (FIG. 12), already discussed. The method 180 may be implemented in logic instructions (e.g., software) such as the instructions 172 (FIG. 13), configurable logic, fixed-functionality hardware logic, etc., or any combination thereof. Illustrated processing block 182 determines a target curvature of the actuator, wherein the actuator includes a circular sidewall having an inner surface, a first edge and a second edge. The actuator also includes a plurality of radial members extending from a hub of the actuator to the inner surface of the circular sidewall, wherein the circular sidewall and the plurality of radial members are compliant. Block 184 applies a force to an inner end of each radial member at the hub based on the target curvature of the actuator, wherein application of the force to the inner end of the radial member at the hub causes an outer end of the radial member to displace the second edge of the circular sidewall to a greater extent than the first edge of the circular sidewall.

As already noted, displacement of the second edge to the greater extent than the first edge generates the target curvature in a profile of the actuator. Additionally, the inner end of each radial member may include a fixed portion and a compressible portion. In such a case, the force applied to the inner end of each radial member may be a compressive force.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. An actuator assembly comprising:
one or more motors; and
a plurality of actuators coupled to the one or more motors, wherein each actuator includes:
a circular sidewall having an inner surface, a first edge and a second edge, and
a plurality of radial members extending from a hub of the actuator to the inner surface of the circular sidewall, wherein application of a force by the one or more motors to an inner end of each radial member at the hub causes an outer end of the radial member to displace the second edge of the circular sidewall to a greater extent than the first edge of the circular sidewall, and wherein each actuator is coupled to two or more other actuators via sidewall connections.

2. The actuator assembly of claim 1, wherein the circular sidewall and the plurality of radial members are compliant.

3. The actuator assembly of claim 1, wherein displacement of the second edge to the greater extent than the first edge generates a curvature in a profile of each actuator.

4. The actuator assembly of claim 3, wherein the curvature is a circle packing curvature.

5. The actuator assembly of claim 1, wherein the inner end of each radial member includes a fixed portion and a compressible portion, and wherein the force applied to the inner end of each radial member is a compressive force.

6. The actuator assembly of claim 1, wherein each radial member includes surfaces defining a plurality of void regions.

7. The actuator assembly of claim 1, wherein the plurality of radial members are associated with a level set optimization procedure.

8. The actuator assembly of claim 1, wherein the plurality of radial members includes six radial members.

9. The actuator assembly of claim 1, wherein the plurality of actuators includes twenty-four actuators.

10. An actuator comprising:
a circular sidewall having an inner surface, a first edge and a second edge; and
a plurality of radial members extending from a hub of the actuator to the inner surface of the circular sidewall, wherein application of a force to an inner end of each radial member at the hub causes an outer end of the radial member to displace the second edge of the circular sidewall to a greater extent than the first edge of the circular sidewall.

11. The actuator of claim 10, wherein the circular sidewall and the plurality of radial members are compliant.

12. The actuator of claim 10, wherein displacement of the second edge to the greater extent than the first edge generates a curvature in a profile of the actuator.

13. The actuator of claim 12, wherein the curvature is a circle packing curvature.

14. The actuator of claim 10, wherein the inner end of each radial member includes a fixed portion and a compressible portion, and wherein the force applied to the inner end of each radial member is a compressive force.

15. The actuator of claim 10, wherein each radial member includes surfaces defining a plurality of void regions.

16. The actuator of claim 10, wherein the plurality of radial members are associated with a level set optimization procedure.

17. The actuator of claim 10, wherein the plurality of radial members includes six radial members.

18. A method comprising:
determining a target curvature of an actuator, wherein the actuator includes a circular sidewall having an inner surface, a first edge and a second edge, and a plurality of radial members extending from a hub of the actuator to the inner surface of the circular sidewall, and wherein the circular sidewall and the plurality of radial members are compliant; and
applying a force to an inner end of each radial member at the hub based on the target curvature of the actuator, wherein application of the force to the inner end of each radial member at the hub causes an outer end of the radial member to displace the second edge of the circular sidewall to a greater extent than the first edge of the circular sidewall.

19. The method of claim 18, wherein displacement of the second edge to the greater extent than the first edge generates the target curvature in a profile of the actuator.

20. The method of claim 18, wherein the inner end of each radial member includes a fixed portion and a compressible portion, and wherein the force applied to the inner end of each radial member is a compressive force.
